(19) United States
(12) Patent Application Publication
(10) Pub. No.: US 2008/0192292 A1
(43) Pub. Date: Aug. 14, 2008

(54) PRINTING APPARATUS, PRINTING METHOD, COMPUTER PROGRAM PRODUCT, AND PRINTING SYSTEM

(75) Inventor: Jun Ikeda, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/062,494

(22) Filed: Apr. 3, 2008

Related U.S. Application Data
(63) Continuation of application No. 10/422,818, filed on Apr. 25, 2003.

(30) Foreign Application Priority Data
Apr. 26, 2002 (JP) 2002-127194

(51) Int. Cl. G06F 15/00

(52) U.S. Cl. 358/1.15

(57) ABSTRACT

An image required for printing can easily be generated, and printing that satisfies user's needs can be achieved by obtaining image information stored in a image data server, obtaining user-specific information from an external device, generating a printing image based on the obtained image information and the obtained user-specific information, and printing the generated printing image.

### BACKGROUND OF THE INVENTION

1. Field of the Invention

The present invention relates to a printing apparatus, which is connected to a network, such as Internet, and being capable of obtaining information required for printing an printed material from a data supplier, which is connected to the same network, and printing the printed material using obtained information, and to a printing method, a computer program product, and a printing system using the same.

2. Description of the Related Art

In the related art, when printing greeting cards such as New Year's greeting cards, Summer greeting cards, and other greeting cards, the user writes contents by hand on pieces of mailable paper such as a postal card.

However, the user may want to send cards to the intended addresses with background and predetermined phrases or the like finely printed thereon.

In such a case, for example, the user may order materials that the user wants to send to a printing service supplier by the hundred.

In such a case, for example, the user may select and buy ready-printed decad postal cards from the shelves in the store, such as a convenience store.

Then, the user writes addresses on these postal cards using a writing tool, such as a pen, by hand, and drops them into a mailbox.

However, there is a case in which the number of postcards that the user want to send is not so many and thus the user cannot order the printing service supplier.

There is a case in which the user cannot find desired ready-printed postcards in the store because no stock is available.

In such cases, the customer cannot have satisfactory service. Simultaneously, the seller looses a commercial opportunity.

Recently, computers or printers are personalized. There are many cases that the user manages data, such as an address book, as a database on the personal computer.

There is a case in which the user sends a huge number of postcards. In such a case, the user prints addresses on the ready-printed postcards obtained in the manner described above using the database that the user manages on the personal computer, and the personal printer, which is a troublesome job.

### SUMMARY OF THE INVENTION

In order to remove the problems in the related art as described above, the invention rationalizes such a printing job by feeding the ready-printed postcards or the like, which the user wants to send, by a required number based on a print-on-demand system via the network, and then printing personal data, such as addresses, which is a troublesome job, using means such as the network, or a memory card.

The invention is intended to provide a printing apparatus, which contributes to increase user satisfaction and increase commercial opportunities of the supplier, and a printing method, a computer program product, and printing system using the same.

In order to achieve the object described above, the printing apparatus according to the invention is a printing apparatus connected to a image data server, in which image information is stored, via a network, including an acquisition means for obtaining image information stored in the image data server, a user-specific information acquisition means for obtaining user-specific information from an external device, a generation means for generating a printing image based on the image information and the user-specific information, and a printing means for printing the generated printing image.

### BRIEF DESCRIPTION OF THE DRAWINGS

FIG. 1 is a general schematic drawing of a printing system according to a first embodiment of the invention;

FIG. 2 is a block diagram of an image data server 107 used in the printing system shown in FIG. 1;

FIG. 3 is a display screen displayed on the vending user interface 101 of an in-store automatic printing apparatus 100 shown in FIG. 1;

FIG. 4 is a display screen displayed on the vending user interface 101 of the in-store automatic printing apparatus 100 shown in FIG. 1;

FIG. 5 is a display screen displayed on the vending user interface 101 of the in-store automatic printing apparatus 100 shown in FIG. 1;

FIG. 6 is a display screen displayed on the vending user interface 101 of the in-store automatic printing apparatus 100 shown in FIG. 1;

FIG. 7 is a display screen displayed on the vending user interface 101 of the in-store automatic printing apparatus 100 shown in FIG. 1;

FIG. 8 is a display screen displayed on the vending user interface 101 of the in-store automatic printing apparatus 100 shown in FIG. 1;

FIG. 9 is a display screen displayed on the vending user interface 101 of the in-store automatic printing apparatus 100 shown in FIG. 1;

FIG. 10 is a display screen displayed on the vending user interface 101 of the in-store automatic printing apparatus 100 shown in FIG. 1;

FIG. 11 is a display screen displayed on the vending user interface 101 of the in-store automatic printing apparatus 100 shown in FIG. 1;

FIG. 12 is a display screen displayed on the vending user interface 101 of the in-store automatic printing apparatus 100 shown in FIG. 1;

FIG. 13 is a display screen displayed on the vending user interface 101 of the in-store automatic printing apparatus 100 shown in FIG. 1;

FIG. 14 is a display screen displayed on the vending user interface 101 of the in-store automatic printing apparatus 100 shown in FIG. 1;

FIG. 15 is a display screen displayed on the vending user interface 101 of the in-store automatic printing apparatus 100 shown in FIG. 1;

FIG. 16 is a display screen displayed on the vending user interface 101 of the in-store automatic printing apparatus 100 shown in FIG. 1;

FIG. 17 is a display screen displayed on the vending user interface 101 of the in-store automatic printing apparatus 100 shown in FIG. 1;

FIG. 18 is a display screen displayed on the vending user interface 101 of the in-store automatic printing apparatus 100 shown in FIG. 1;

FIG. 19 is a display screen displayed on the vending user interface 101 of the in-store automatic printing apparatus 100 shown in FIG. 1;

FIG. 20 is a display screen displayed on the vending user interface 101 of the in-store automatic printing apparatus 100 shown in FIG. 1;

FIG. 21 is a flowchart showing a stream of process in the printing system shown in FIG. 1;

FIG. 22 is a flowchart showing a stream of process in the printing system shown in FIG. 1;

FIG. 23 is a flowchart showing a stream of process in the printing system shown in FIG. 1; and

FIG. 24 is a flowchart showing a stream of process in the printing system shown in FIG. 1.

### DESCRIPTION OF THE PREFERRED EMBODIMENT

Referring now to the drawings, preferred embodiment of the invention will be described in detail. Dimensions, materials, shapes, of the components and relative positioning thereof stated in the embodiment are not limited thereto unless otherwise specified.

Similar parts are represented by the same reference numerals throughout the drawings.

The descriptions given in conjunction with the respective embodiments of the printing system according to the invention are also applied to the embodiments of a printing apparatus, a printing method and a computer program product according to the invention.

### First Embodiment of the Printing System

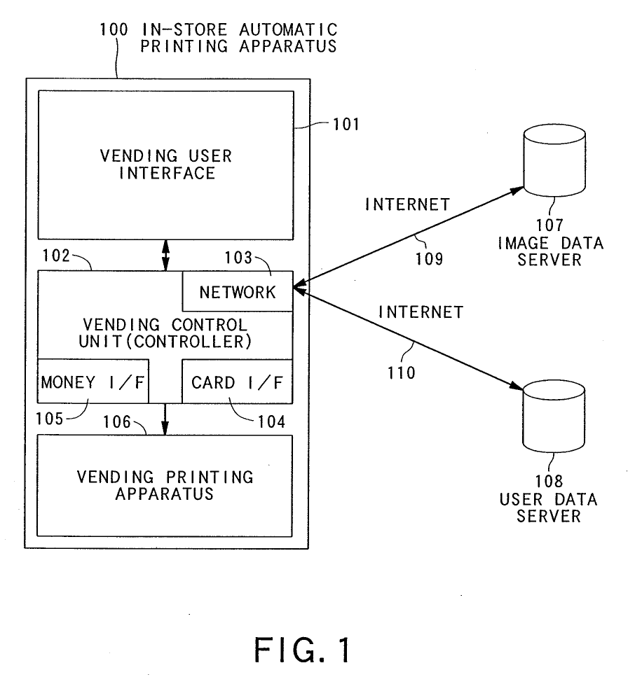

Referring now to the drawings, a first embodiment of the printing system according to the invention will be described. FIG. 1 is a general perspective view of a first embodiment of a printing system according to the present invention.

In FIG. 1, reference numeral 100 shows an in-store automatic printing apparatus installed in the store (corresponds to a printing apparatus according to the invention). Reference numeral 101 designates a vending user interface, which is an interface between the user, who operates the in-store automatic printing apparatus 100 and the in-store automatic printing apparatus 100.

The vending user interface 101 includes an input element, such as a touch panel, and an output element, such as a CRT display, to be more precise.

However, as will be described later, the vending user interface 101 is not specifically limited as long as it enables intercommunication with the user.

Reference numeral 102 designates a vending control unit (controller) for controlling the entire in-store automatic printing apparatus 100.

The controller of the vending control unit 102 includes a network unit 103, which is connected to the network, such as Internet, and establishes data exchange, a card interface (card I/F) 104, to which data from a data storage medium, such as a memory card that will be described later, can be input, a money interface (money I/F) 105, which is already provided in normal vending machines for exchanging money, through which the user inserts the specified amount of money, and receives change if necessary, when charging to the user, which will be described later.

Reference numeral 106 designates a vending printing apparatus for printing an image data specified by the vending control unit 102 onto a medium such as paper (postal card in the present embodiment).

In the case of the present embodiment, the rasterize of the printing image data is performed by the vending control unit 102.

The vending printing apparatus 106 has a function to print the image data output from the vending control unit 102.

However, the point to perform rasterize, the method of generating the image data for printing, and detailed method of exchanging data between the control unit and the printing apparatus are not specifically limited as long as printing is realized.

Reference numeral 107 designates an image data server, in which the printing image data specified by the user, which is compiled with a database in advance, is stored in a quality that can satisfy the user's need when using the printing system according to the present embodiment.

The image data server 107 does not limit the structure of a hardware and software.

However, the image data server 107 includes a high-capacity hard disk and a disk in which the image data, which is compiled with a database, is stored, mounted thereon.

The image data sever 107 is a computer system including a network interface, such as Internet.

The image data server 107 includes a software, which is capable of approval of the client source, data retrieval, and data output based on instructions from a client received through the network.

Reference numeral 108 is a user data server provided for realizing optional functions.

The user data server 108 is established by the user.

The user data server 108 is a server for a user-specific data access, which will be described later.

In the present embodiment, the user uses the user data server 108 in such a manner that the user compiles address information of the destinations of the printed materials, text information, which is data used when printing a text on the printed material, with a database, and stores in the user data server 108, as in the case of the image data server 107.

The user data server 108 realizes, upon request of the user through the in-store automatic printing apparatus 100, access approval, data retrieval in the database, and supply of retrieved data.

The user data server 108 is basically constructed in the same manner as the image data server 107, except for data to be supplied.

Reference numeral 109 designates a network for establishing data exchange between the in-store automatic printing apparatus 100 and the image data server 107 when operating the system.

In the present embodiment, Internet is taken as an example of the network 109.

Reference numeral 110 designates a network for establishing data exchange between the in-store automatic printing apparatus 100 and the user data server 108 in which the user-specific data is stored when operating the system.

The network 110 is, in the present embodiment, Internet.

However, though Internet is taken as an example of the networks 109 and 110 in the present embodiment, it may be a common network, and may be separate networks.

The networks 109 and 110 may be a method of exchanging data through a telephone line or directly through a modem, but not through the network.

Whether they are constantly connected or not is no matter in implementation and realization of the invention, and affect only on the speed of service.

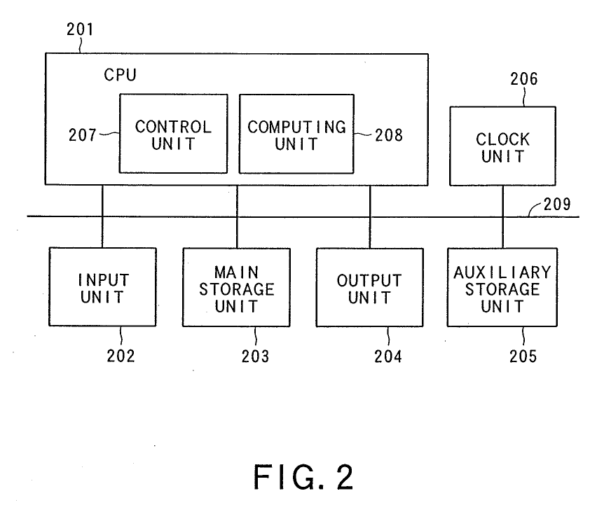

Referring now to FIG. 2, the construction of the image data server 107 shown in FIG. 1 will be described. FIG. 2 is a block diagram of the image data server 107 used in the printing system shown in FIG. 1.

As shown in FIG. 2, the image data server 107 includes a CPU (Central Processing Unit) 201, an input element 202, a main storage unit 203, an output element 204, an auxiliary storage unit 205, and a clock unit 206.

The CPU 201 is a component, which is otherwise referred as a processing unit. The CPU 201 includes a control unit 207 for issuing instructions to the respective sections in the system and controlling the actions thereof, and a computing unit 208, which is a main part of the server for performing processing of digital data.

In this case, the CPU 201 works as a single unit, with other components shown in FIG. 2, or in cooperation with programs stored in the main storage unit 203 or in the auxiliary storage unit 205.

The control unit 207 reads data supplied into the input element 202 or procedure, which is provided in advance (for example, a program or a software), according to clock timings issued by the clock unit 206 into a main storage unit 203.

The control unit 207 issues an instruction to the computing unit 208 based on the read-in contents, and make it perform processing. The results of processing are transmitted to the internal devices or external devices, such as the main storage unit 203, the output unit 204 and the auxiliary storage unit 205, based on control of the control unit 207.

The input unit 202 is a component for supplying various data, including a keyboard, a mouse, a pointing device, a touch panel, a mouse pad, a CCD camera, a card reading device, a punch tape reading device, and a magnetic tape.

The main storage unit 203 is a component, which is otherwise referred to as a memory. The main storage unit 203 is a component for defining an addressable storage space used for performing instruction in the processing unit and in the internal storage unit. The main storage unit 203 is mainly constructed of a semi-conductor memory device, and stores and maintains the supplied program or data.

The main storage unit 203 reads out stored and maintained data to, for example, a register, based on the instruction from the control unit 207.

The semi-conductor memory device constituting the main storage unit 203 may be a RAM (Random Access Memory) or a ROM (Read Only Memory).

The output unit 204 is a component for supplying the computing results of the computing unit 208. The output unit 204 includes, for example, a display unit, such as a CRT, a plasma display panel, and a liquid crystal display, a printing unit, such as a printer, and an audio output unit.

The auxiliary storage unit 205 is a component for supplementing the storage capacity of the main storage unit 203. Media that can be used for the auxiliary storage unit 205 includes not only a CD-ROM or a hard disk, but also a writable, for example, write-once CD-R and DVD-R, phase-change recording CD-RW, DVD-RAM, DVD+RW, and PD, a magneto-optic storage medium, a magnetic recording storage medium, a removable HDD storage medium, and a flash memory storage medium.

The respective components are connected by buses 209 with each other.

In the image data server 107 of the present embodiment, if there is any unnecessary components in FIG. 2, they may be eliminated as needed.

For example, the display constituting the output unit 204 may not be necessary.

In such a case, in the image data server 107 according to the invention, the output unit 204 may not be necessary.

The numbers of the main storage units 203 and the auxiliary storage units 205 is not limited to one, and it may be arbitrary number.

The more the number of the main storage units 203 and of the auxiliary storage units 205, the more the anti-interruption property of the image data server is improved.

Various programs according to the invention may be stored in at least either one of the main storage unit 203 and the auxiliary storage unit 205.

Therefore, at least either one of the main storage unit 203 and the auxiliary storage unit 205 may be applied as the storage medium including a program stored therein, which the computer can read.

What is important is that division of the database must be conceptual division of information, and the physical differentiation of the storage media is nothing to do with it.

Therefore, a plurality of databases may conceptually represent a plurality of groups of information stored in a single magnetic disk or a single optical disk. In contrast, a single database may conceptually represent a group of single information stored in a plurality of magnetic disks or in the optical disks.

Although only the internal construction of the image data server 107 shown in FIG. 1 has been described in the description shown above, the internal construction of the user data server 108 shown in FIG. 1 is also the same as that in FIG. 2, and thus the same description is applied.

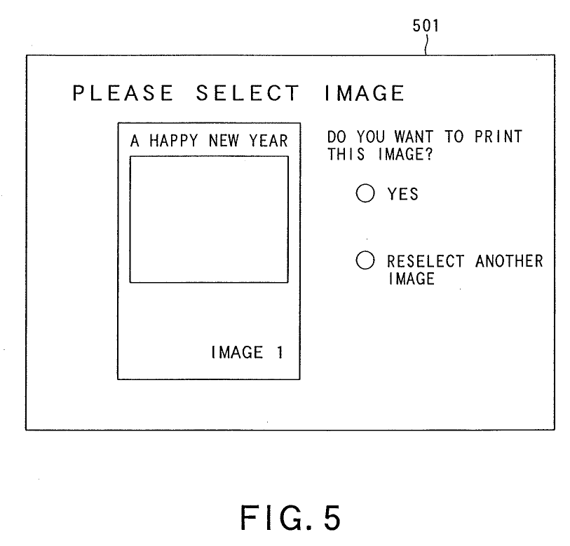

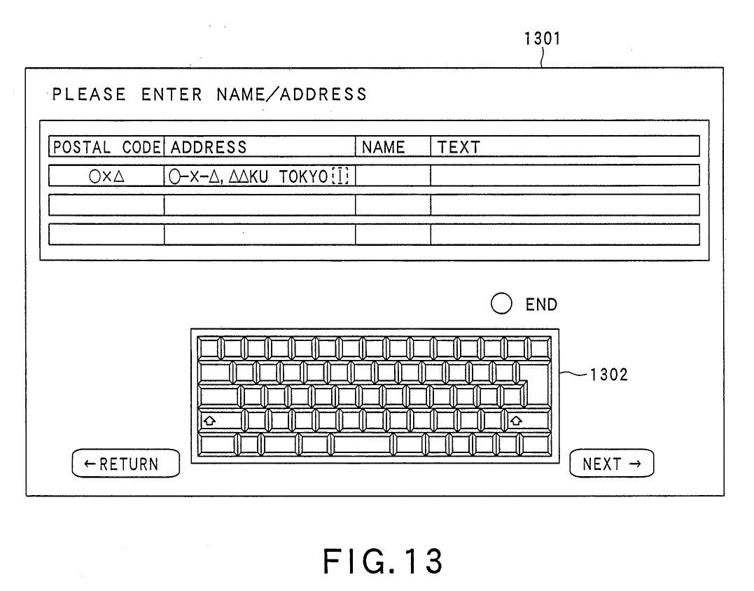

Referring now to FIG. 1 to FIG. 24, the action of the printing system according to the first embodiment of the invention will be described.

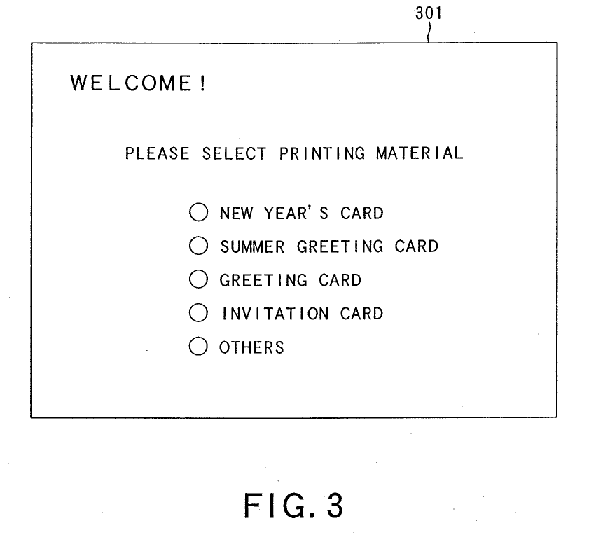

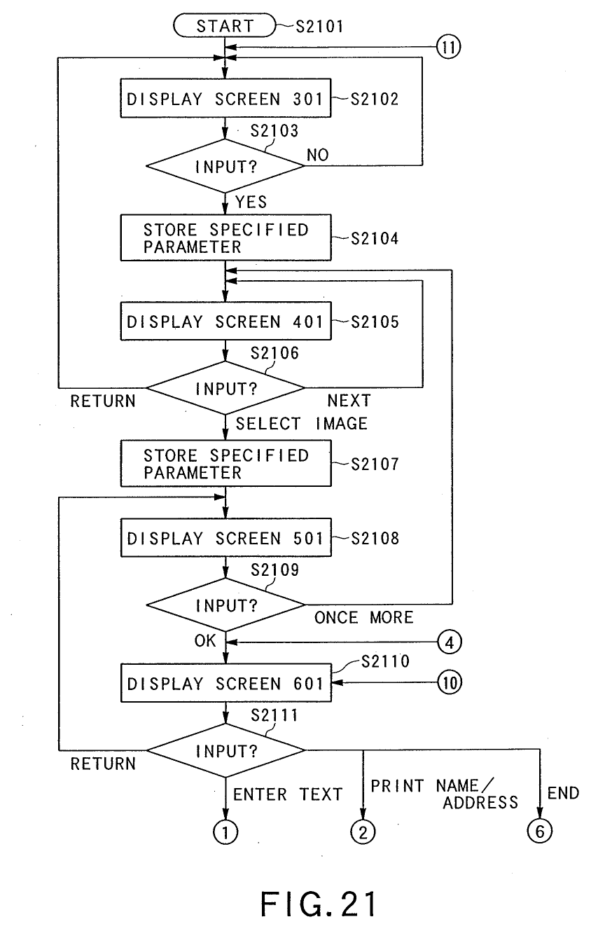

FIG. 3 to FIG. 20 show a display screen displayed on the vending user interface 101 of the in-store automatic printing apparatus 100 shown in FIG. 1. FIG. 21 to FIG. 24 are flowcharts showing a stream of the process performed in the printing system in FIG. 1.

As shown in FIG. 21, the in-store automatic printing apparatus 100 terminates a predetermined initialization before the user comes to the shop (S2101).

Then, the in-store automatic printing apparatus 100 boots up and displays a screen 301 shown in FIG. 3 on the vending user interface 101 (S2102).

On the other hand, the user stands in front of the in-store automatic printing apparatus 100 in order to purchase a desired printing material by using the in-store automatic printing apparatus 100.

Then the user looks at the display shown on the screen 301 in FIG. 3.

The user selects a desired printing category from the menu on the screen 301. After the user input an entry, the procedure goes to the step S2104. If the user does not input any entry, the procedure goes back to the step S2102, where the screen 301 is displayed (S2103).

In the present embodiment, the vending user interface 101 provided on the in-store automatic printing apparatus 100 is constructed of the display means and the touch panel means. The user inputs information through the vending user interface 101.

Subsequently, the in-store automatic printing apparatus 100 stores a parameter which is printing category information specified by the user in the control unit in order to use as a user-specified parameter later (S2104).

In the present embodiment, the parameter is stored in a parameter storing area in a work area RAM of software provided in the vending control unit 102. However, storage of the parameter of the invention is not specifically limited thereto.

Subsequently, the vending control unit 102 transmits the user-specified parameter stored in the previous step S2104 via the network 109 to the image data server 107 as data.

The image data server 107 returns image information belonging to the category to the vending control unit 102 through the network 109.

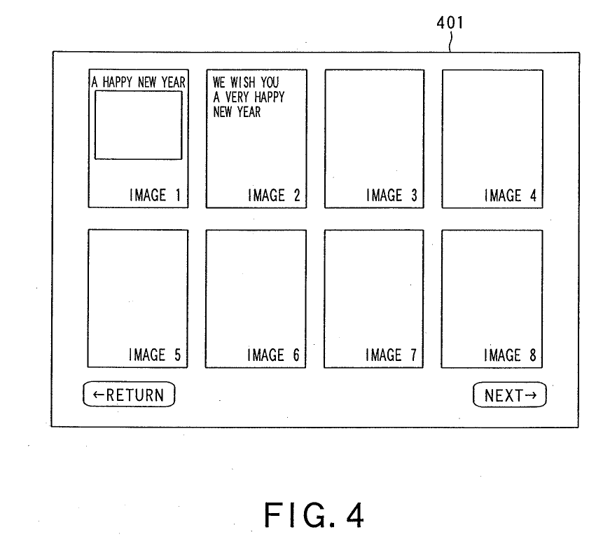

The vending control unit 102 displays a screen 401 shown in FIG. 4 on the display of the vending user interface 101 based on the returned data (S2105).

The vending control unit 102 issues a data request to the image data server 107 using TCP/IP protocol in this embodiment, though detailed method for realizing this procedure is not specifically limited thereto.

The IP address of the image data server is already set by the maintenance staff.

The vending control unit 102 transmits the user-specified category (for example the category of “New year's greeting card”) as a data request to the image data server 107.

In the present embodiment, though it is not specifically shown in the drawing, for example, a setting that approves the data request is made for the IP address, which is allocated to the network 103 in the vending control unit 102 in the in-store automatic printing apparatus 100, for security reasons.

However, the invention is not specifically limited thereto.

For example, in the invention, such a tactic that an access password for the image data server 107 is preset in the vending control unit 102 of the in-store automatic printing apparatus 100, and access to the image date server 107 is approved by entering the password may be applied.

The image data server 107 retrieves an image date that corresponds to the requested image category from a database provided in the image data server 107.

Then, the image data server 107 transmits the retrieved image data to the vending control unit 102, which is a requester, via a requested path, that is, the network 109 and the network 103.

The present embodiment is constructed as a system that puts emphasis on the printing quality.

When transmitting all the image data that the user can specify from the database through the network 109, a communication of a large amount of data, that is, a large bus traffic occurs.

In such a data transmission, a relatively long time is required.

Therefore, in the present embodiment, data transmission is made in the form of data shown in a screen 401, that is, in the form of a thumbnail view (High-resolution data transmission used for printing is not made in this stage).

With such a data transmission, according to the present embodiment, a data transmission time required for one selectable image is reduced.

Simultaneously, in the present embodiment, the image data is compressed into the form of JPEG, which is publicly known, when transmitting in order to reduce the data transmission time.

In the present embodiment, when displaying an image data on the vending user interface 101, the compressed image data is uncompressed by a JPEG uncompressing unit (either software or hardware) provided in the vending control unit 102, which is not shown, and the received compressed image data is displayed as an image before compression.

Subsequently, the printing system of the present embodiment waits for data entry from the user while displaying the screen 401, and data supplied by the user is subjected to processing and branching (S2106).

The user can select one of options, “RETURN”, “NEXT” or “IMAGE SELECTED”, as shown on the screen 401.

Selection of image is performed in the same manner as specification of other options.

In other words, the user selects a desired image from images shown on the display of the vending user interface 101.

When the user presses the selected image on the screen with his/her finger, the touch panel is activated.

With this operation, the specification of the user is transmitted to the vending control unit 102.

The in-store automatic printing apparatus 100 goes to the step S2102 if the button “RETURN” is selected in this step, and returns to the page where images are displayed.

On the other hand, if “NEXT” is selected, the procedure goes back to the step S2105.

The in-store automatic printing apparatus 100 makes the image data server 107 retrieve the next candidate, and receives the image.

The in-store automatic printing apparatus 100 displays the screen 401 for selecting the next candidate.

On the other hand, if the image is selected in this step, the procedure goes to the step S2107.

In the step S2107, the in-store automatic printing apparatus 100 stores the ID number for identifying the output image data specified by the user in the step S2106 as the user-specified parameter as in the step S2104, and goes to the next step S2108. The parameter stored in this step is used in another step, which will be described later.

Subsequently, the in-store automatic printing apparatus 100 displays a screen 501 on the vending user interface 101, and prompts the user to confirm his/her specification (S2108).

The image data shown here maybe the same as data displayed on the screen 401.

In addition, the image data to be displayed here may be those obtained by requesting high-resolution data as in the case of data access to the image data server 107 for displaying images on the screen 401 in order to prompt the user to conform the specified image.

Then the procedure goes to the step S2109 and waits for entries of the user confirmation. In this step, the user can specify “OK” or “SELECT ANOTHER IMAGE” by using the touch panel of the vending user interface 101.

If the user selects the former, the procedure goes to the step S2110, and if the user selects the latter, the procedure goes back to the step S2105.

The method of displaying the screen 401 in the step S2105 when the “SELECT ANOTHER IMAGE” is selected is not specifically limited.

In the present embodiment, if the user displays the screen 401 of the next candidate in the previous step, the screen of the next candidate is displayed in this step.

However, it is not limited thereto, and the screen 401 that was displayed initially when the procedure went to the step S2105 before the user selects the next candidate may be displayed.

When comparing the time required for data access through the network and the time required for accessing to a secondary storage device, such as the memory or the hard disk provided in the hard disk, the latter is faster than the former generally.

Therefore, the memory or the hard disk provided in the apparatus is used as a data cash area in many cases, and the present embodiment also employs this access method. However, it is not specifically limited thereto.

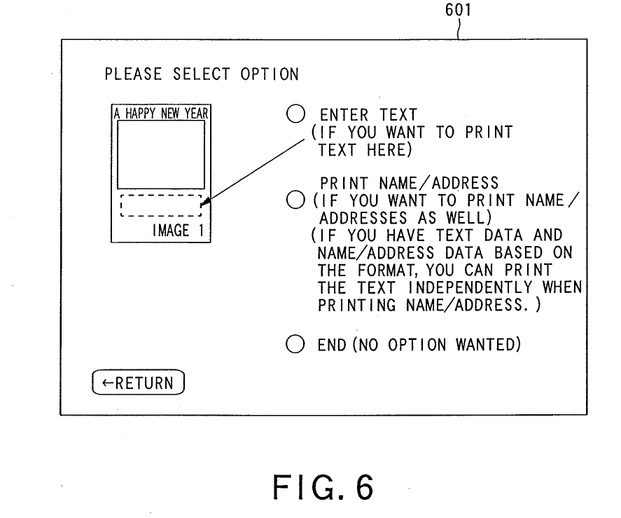

When the image data for printing is selected by the user in the step S2109, the in-store automatic printing apparatus 100 displays a screen 601 shown in FIG. 6 on a display device provided on the vending user interface 101 in the same manner as the previous displaying step (S2110), and prompts the user to specify the option (S2111).

Options that can be selected in the step S2111 includes “ENTER TEXT”, “PRINT NAME/ADDRESS”, and “END”, that is, “NO OPTION WANTED”. Then the procedure goes to the steps, S2116, S2124, and S2152 according to the users specification.

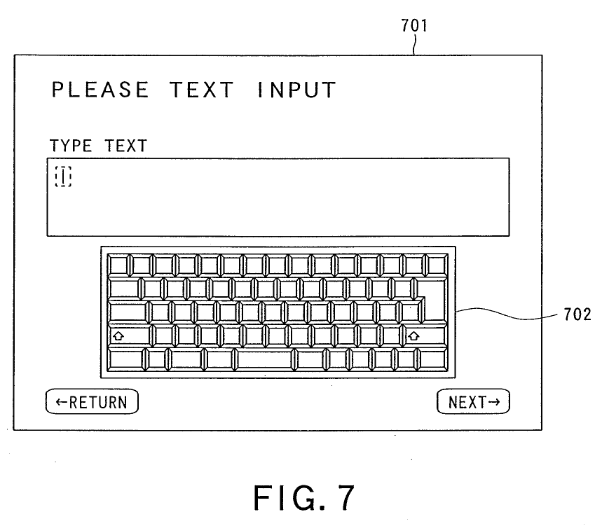

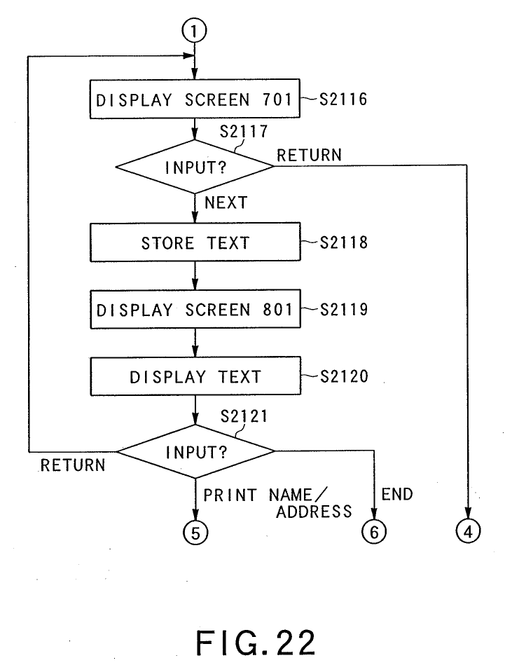

When the user specified ENTER TEXT option in the step S2111, the in-store automatic printing apparatus 100 displays a screen 701 shown in FIG. 7 on the display device provided on the vending user interface 101, and prompts the user to enter the text (S2116: the flowchart shown in FIG. 22).

In this case, since the in-store automatic printing apparatus 100 is not provided with a keyboard as an input device, a keyboard screen 702 is displayed on the touch panel, though it is not specifically limited thereto.

In this manner, the in-store automatic printing apparatus 100 displays a so-called soft keyboard, with which the user can input characters as if he/she operates the keyboard.

The user enters characters by operating the soft keyboard through the touch panel.

As described above, the soft keyboard is displayed in the present embodiment.

However, in the invention, other system, such as 51-Hiragana notation system for Japanese language, may be employed, or a hard keyboard may be provided on the apparatus for typing the text.

Since the invention does not limit the operating method when entering Japanese text, it is not specifically described here.

In the task of displaying the image and of entering the text on the screen 701 in the step S2116, “RETURN” and “NEXT” buttons shown on at the lower left and right corners on the screen 701 form a call of interrupt processing task.

When these buttons are pressed, the in-store automatic printing apparatus 100 detects that the user finished input of data that should be entered when the screen 701 is displayed (S2117).

When the user presses the button “NEXT”, the procedure goes to the step S2118, and when the user presses the button “RETURN”, the procedure goes to the step S2110 shown in FIG. 21.

When the button “NEXT” is pressed, the procedure goes to the step S2118, the in-store automatic printing apparatus 100 stores data entered in the steps S2116 to S2117 in the text storage area mapped in advance in the storage unit in the apparatus as text data to be printed prepared by the user (S2118).

The text data stored in this step is used later.

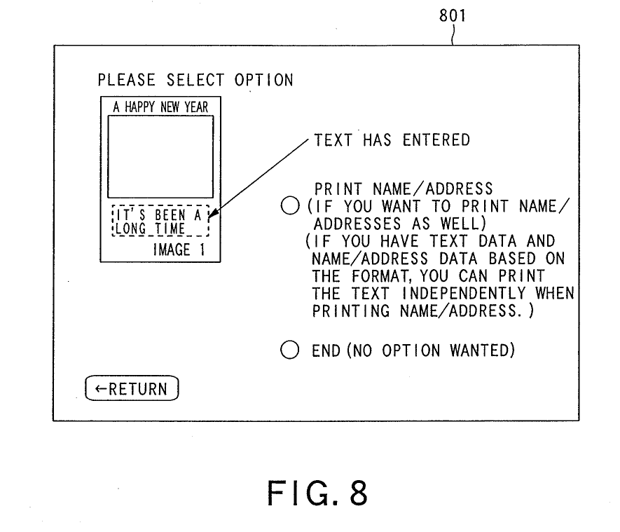

The in-store automatic printing apparatus 100 displays a screen 801 shown in FIG. 8 on the display device provided on the vending user interface 101 (S2119).

The in-store automatic printing apparatus 100 displays the text data that was entered in the previous step to the user in the form of a preview together with various data selected in the preceding steps (S2120).

In the present embodiment, a step to prompt the user to confirm is provided here.

In the step of image display on the screen 801, the option that the user can select is a destination name/address printing service in this embodiment.

The in-store automatic printing apparatus 100 prompts the user to determine whether or not the user want to use this service on the screen (S2121).

When the user specifies the destination name/address printing service option (more specifically, when the user presses around button positioned on the left side of the indication of “PRINT NAME/ADDRESS” on the screen 801), the procedure goes to the step S2124, and when the “END” button is pressed, the procedure goes to the step S2152.

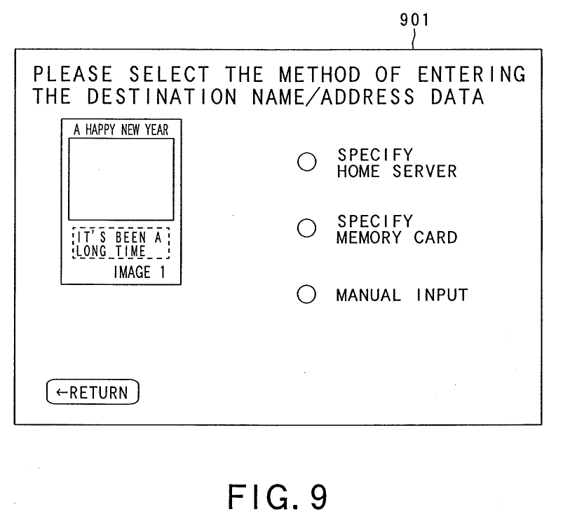

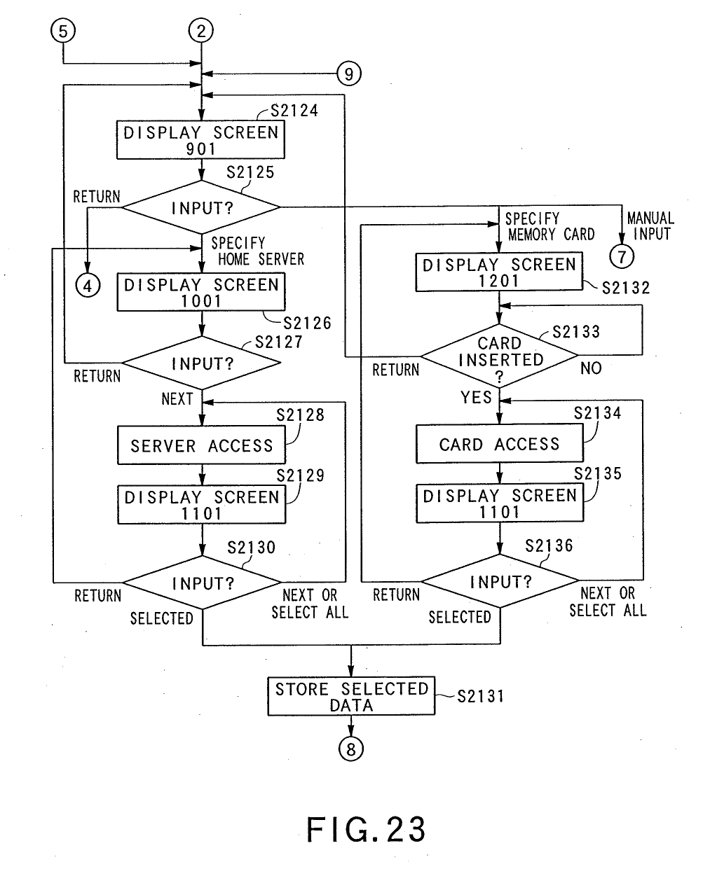

In the step S2124 shown in FIG. 23, when the user selects the destination name/address printing service in the previous step S2121, the in-store automatic printing apparatus 100 displays the image shown on a screen 901 in FIG. 9 on the display device provided on the vending user interface 101, and prompts the user to select the method of entering the destination name/address data specification (S2125).

In the step S2125, if the user presses the button “HOME SERVER” on the screen 901, the procedure goes to the step S2126, when the button “MEMORY CARD” is pressed, the procedure goes to the step S2132, when the button “MANUAL INPUT” is pressed, the procedure goes to the step S2141, and when the button “RETURN” is pressed, the procedure goes to the step S2110.

The user selects the option by selecting the display button on the touch panel as those described thus far.

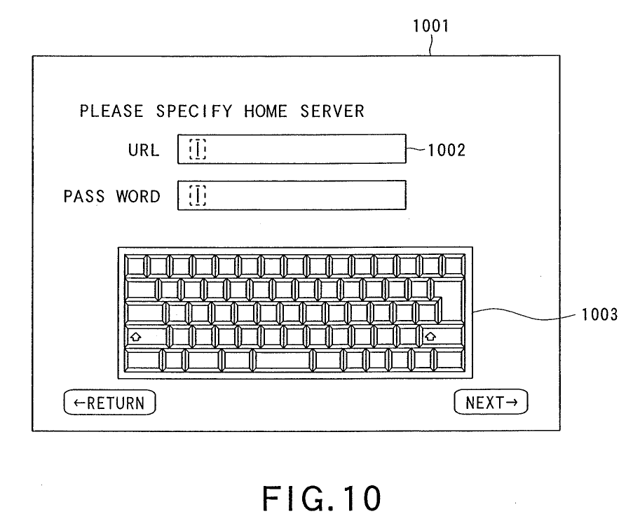

If the user specifies “HOME SERVER” in the step S2125, the in-store automatic printing apparatus 100 displays an image on a screen 1001 shown in FIG. 10 on the display device provided on the vending user interface 101.

The in-store automatic printing apparatus 100 prompts the user to input an URL that corresponds to the address of the home server (S2126).

The user enters the URL of the home server in the area corresponding to an URL input column 1002 in FIG. 10, more specifically, as in the case of a method of entering the text described in conjunction with FIG. 7, through a keyboard screen 1003 on the display.

Though a password for the home server access can be entered, in the present embodiment, the presence of this column is no object.

Although the position of the input cursor (the position to input the text) can be changed as desired by the user through the touch panel as it was thus far, how to enter the text is not specifically limited thereto in the invention.

Subsequently, when the button “RETURN” at the bottom on the screen is pressed on the screen 1001, the procedure goes back to the step S2124, and when the button “NEXT” is pressed, the procedure goes to the step S2128 (S2127).

If the user presses the button “NEXT” in the step S2127, that is, if the user inputs complete information for accessing to the home server, the in-store automatic printing apparatus 100 accesses to the user data server 108 for obtaining data in the destination name/address database via the network 103 and the network 110 (S2128).

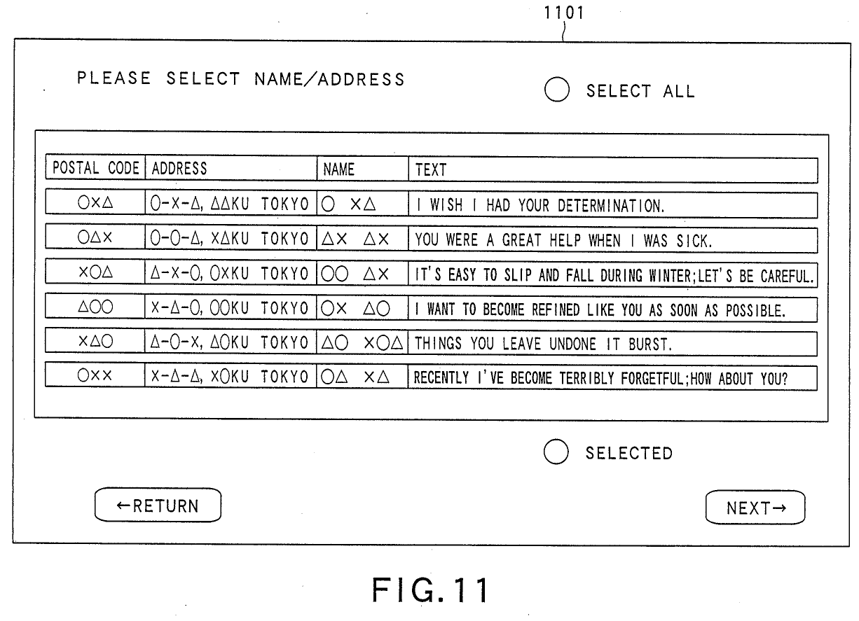

Subsequently, if the in-store automatic printing apparatus 100 accesses to the destination name/address database stored in the user data server 108, and obtains data, it displays a screen 1101 shown in FIG. 11, and prompts the user to select the address data to be printed (S2129).

The case where any troubles occurs when accessing to the user data server 108 due to some reasons such as an error in the URL of the user data server 108 that the user has entered in the previous steps to S2127, or failures existing in the access line will be described.

In this case, though not specifically stated in the present embodiment, the apparatus must simply display to notify the details of the failure to the user and return to the step S2126 for prompting the user to re-enter the URL or return to the corresponding step according to the error occurred, and hence no specific processing is required. Therefore, detailed description about such a case will not be described.

The user selects the displayed data on the screen 1101 by touching the corresponding part on the touch panel and toggling the options through touch operation as in the case described thus far.

The user is notified of the selected state by highlighting effect.

The display forms or selecting method are already realized by equipment constructed of the software or the hardware that provides the same operation, and thus are not specifically limited.

As the last specification on the screen 1101, three options of “SELECT ALL”, “RETURN”, and “NEXT” are provided in the present embodiment.

When the button “SELECT ALL” is pressed, the in-store automatic printing apparatus 100 highlights all the destination name/address data listed there.

Accordingly, the in-store automatic printing apparatus 100 notifies the user that displayed data is selected entirely.

Then the procedure goes back to the step S2128 to prompt the user to select the next destination name/address data.

When the button “NEXT” is pressed, the in-store automatic printing apparatus 100 returns to the step S2128 and prompts the user to select the next destination name/address data shown.

The difference between the processes made by pressing the button “SELECT ALL” and the button “NEXT” shown in FIG. 11 is that the former moves the entire data displayed on the screen to the temporary storage unit provided in the apparatus as the selected data and highlights it for several seconds for notifying the user of the selected items, and the latter moves only the data already selected individually by the user in the step S2129 to the temporary storage unit provided in the same apparatus and highlights only the selected items for several second.

If the user selects all the items individually, the same processing as the case in which the user selects the “SELECT ALL” is basically performed.

On the other hand, when the button “RETURN” is pressed in the step S2130, the procedure goes back to the step S2126.

In the step S2130, when the button “SELECTED” is pressed, the procedure goes to the step S2131 (S2130).

If the button “NEXT” or “SELECT ALL” is pressed here, the procedures go back to the step S2128 as described above.

Then, the in-store automatic printing apparatus 100 accesses to the next destination name/address data in the user data server 108.

Subsequently, the in-store automatic printing apparatus 100 displays a screen in the form of the screen 1101, and prompts the user to input the additional selection, as in the case described above.

The processing performed when the button “RETURN” is pressed while displaying the screen 1101 for prompting the user to enter the additional selection will now be described.

In this case, the procedure may go back to the step S2126, but may go to the step S2128. In the latter case, the database of the previous page is displayed.

With these steps, the user can determine the destination name/address data as a final decision.

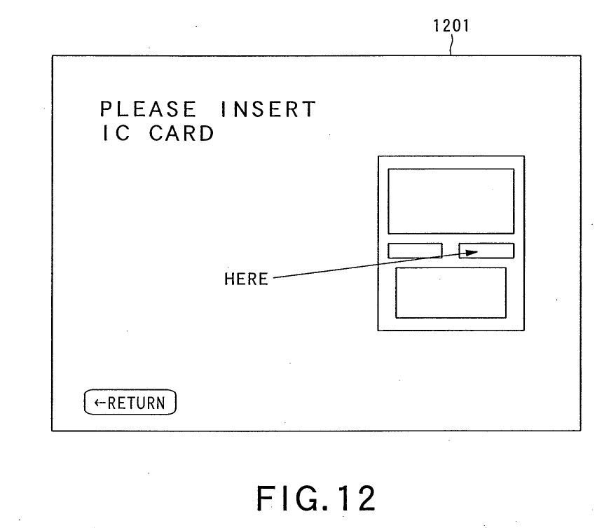

On the other hand, if the user selects MEMORY CARD as a source of the destination name/address data in the step S2125, the in-store automatic printing apparatus 100 displays an image shown on a screen 1201 in FIG. 12 on the display device provided on the vending user interface 101, and prompts the user to load the memory card to the apparatus (S2132).

The type of the memory card to be loaded to the apparatus by the user is not specifically limited.

For example, the memory card may be an IC card as shown in FIG. 12.

In the present embodiment, an information storage medium that the user loads to the apparatus is a memory card.

However, in the invention, the information storage medium to be loaded to the apparatus by the user is not limited thereto, and an optical disk or a magnetic disk may be employed as long as the in-store automatic printing apparatus 100 is provided with a reader.

In addition, it is also applicable to input an address database, which is already printed out by the user in advance, by an OCR.

Subsequently, the in-store automatic printing apparatus 100 determines whether or not the memory card is loaded.

When the memory card is loaded, the procedure goes to the step S2134, and if not, the procedure goes back to a loop of S2133 to wait until the memory card is loaded.

When the user pressed the button “RETURN” on the screen 1201, the procedure goes to the step S2124 (S2133).

In this case, although description is made on condition that the user loads the card to the apparatus, how to sense that the card is loaded is not specifically limited.

Actually, when the waiting time is over, the procedure goes to any one of the previous steps as needed.

Although it is not specifically limited and thus is needed to cope with other errors processing regarding loading of the memory card, it needs to implement processing system suitably.

Subsequently, the in-store automatic printing apparatus 100 accesses the loaded memory card to obtain the destination name/address data (S2134).

Then, as in the step S2129, the in-store automatic printing apparatus 100 displays the screen 1101 shown in FIG. 11, and prompts the user to select the address data that the user wants to print (S2135).

A method of selecting the destination name/address data in this step is the same as in the method of selecting the destination name/address in the step S2129.

Subsequently, as in the step S2130, the in-store automatic printing apparatus 100 determines that the operation on the screen 1101 that is to be performed by the user is finished.

When the button “NEXT” or “SELECT ALL” is pressed, the procedure goes to the step S2134, when the button “SELECTED” is pressed, the procedure goes to the step S2131, and when the button “RETURN” is pressed, the procedure goes to the step S2132 (S2136).

The movements of the series of steps S2126, S2127, S2128, S2129, and S2130, and the series of steps S2132, S2133, S2134, S2135, and S2136 is basically the same, and the only difference is that the former uses the home server via Internet as a source of destination name/address data, and the later uses the memory card that the user loads to the apparatus. The destination name/address data obtained is the same kind.

In the present embodiment, since the format of data stored in the user data server 108 and in the memory card which is connected to the card interface 104, which are taken as an example of the destination name/address data source, and details of the access process are not specifically limited at all, they are omitted from description.

The in-store automatic printing apparatus 100 takes shelter a destination name/address data group, which is specified by the user through the steps described thus far, to a storage unit provided in the apparatus (S2131).

On the other hand, in the step S2125, a case in which the user wants to input data through manual operation on the spot, not through retrieval from the user data server or from the memory card described above, will be described.

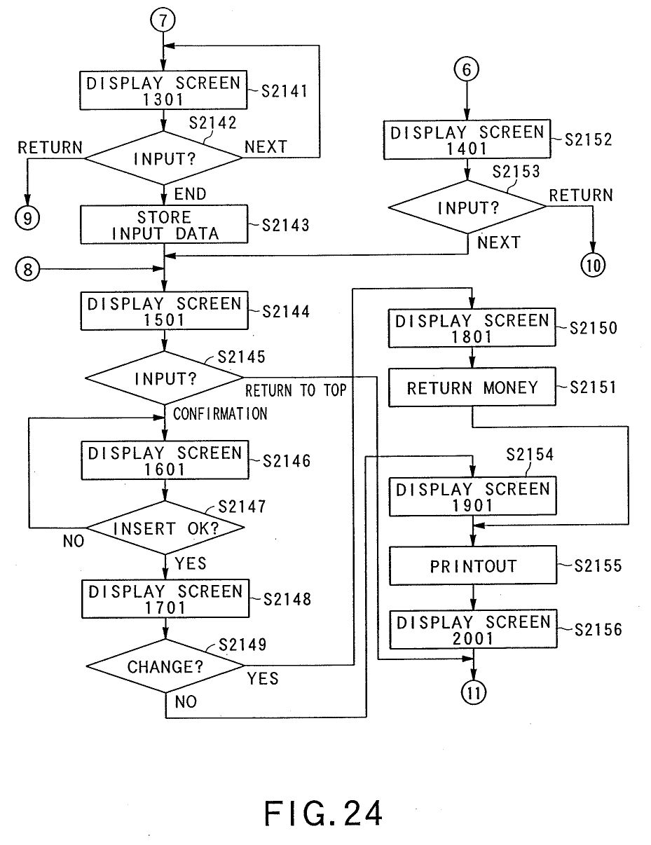

As shown in a flowchart in FIG. 24, the in-store automatic printing apparatus 100 displays a screen 1301 on the display device provided on the vending user interface 101, and prompts the user to enter the destination name/address data (S2141).

Although data input is made through the software keyboard and the cursor movement on the touch panel, and the Kanji translation for entering Kanji is made through a keyboard screen 1302 and the FEP (Front End Processor) function as described in the present embodiment of the invention, they are not limited thereto according to the invention.

Final options regarding the screen 1301 shown in the step S2141 includes “RETURN”, “END”, and “NEXT” in the present embodiment.

If the button “RETURN” is pressed in the step S2142, the procedure goes back to the step S2124 shown in FIG. 23.

When the button “NEXT” is pressed in the step S2142, the procedure goes to the step S2141, and prompts the user to enter the additional destination name/address data continuously using the screen 1301.

In this case, the data, which is already entered, is stored in the temporary storage unit in the apparatus.

When the screen 1301 is displayed, an empty table is displayed, so that data input on the next page is enabled.

If the button “END” is pressed in the step S2142, the group of destination name/address data already entered by the user before this button is pressed is processed as the final destination name/address data group, and the procedure goes to the step S2143 (S2142).

In the present embodiment, as regards the operation to “RETURN” in the step S2142, the procedure goes back to the step S2124 shown in FIG. 23 according to the description given above.

However, as described in conjunction with the operation corresponding to the “RETURN” in the step S2130 and the step S2136, it is also possible to adapt the apparatus to return to the step S2124 when the button “RETURN” is pressed in the processing on the first page, and to return to the step S2141, that is to return to the previous page when the button “RETURN” is pressed in the processing on the second page on.

If the destination name/address data entered by the user's manual operation is settled through the steps S2141 and the step 2142, the in-store automatic printing apparatus 100 stores the data into the storage unit provided in the apparatus as a user's final destination name/address data group as in the same case of the step S2131.

The in-store automatic printing apparatus 100 then processes to enable usage of the data in the subsequent operations (S2143).

The actions of option processing taken when the destination name/address printing options are specified by the user in the description in conjunction with the steps S2124 till now has been described.

The case where the user did not specify the destination name/address option in the step S2121 shown in FIG. 22 will be described.

The present embodiment will be described on the condition that the user takes the printed material back after the printing operation described below has made, and the user writes or prints the destination name/address by another means.

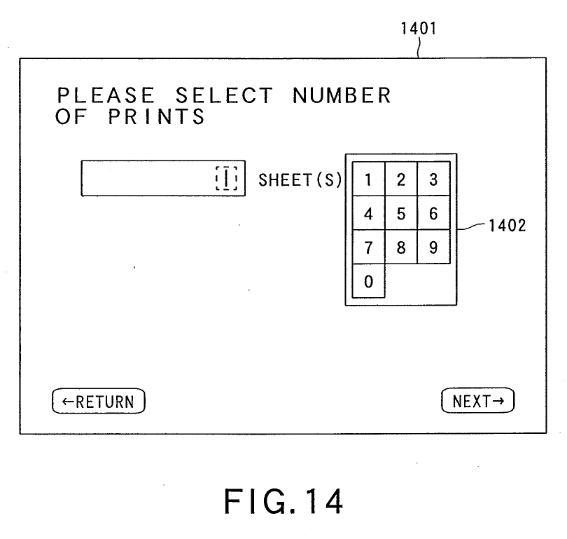

Therefore, in the present embodiment, in order to enable a plurality of printing requests on the same printing material, a screen 1401 shown in FIG. 14 is displayed, and prompts the user to enter the number of materials to be printed (S2152).

The data input by the user in the step S2152, that is, input of the number of materials to be printed, is performed through the soft keyboard and the touch panel as in the description above.

In the step S2152, only a ten-key 1402 of the soft keyboard is displayed as a soft keyboard that the user can use to input the number, and other processing is performed by specifying the position of the cursor through the touch panel.

Subsequently, the options that the user can select as the final settlement on the screen 1401 in the step S2152 will be described.

In the step S2152, two options “RETURN” and “NEXT” are provided.

When the user presses the button “RETURN”, the procedure goes back to the step S2110 shown in FIG. 21, and the in-store automatic printing apparatus 100 prompts the user to select the option again.

The destination resulting from the “RETURN” process may be the step S2116 to enter the text again (In FIG. 24, the procedure goes back to the step S2110).

When the button “NEXT” is pressed in the step S2153, the procedure goes to the step S2144.

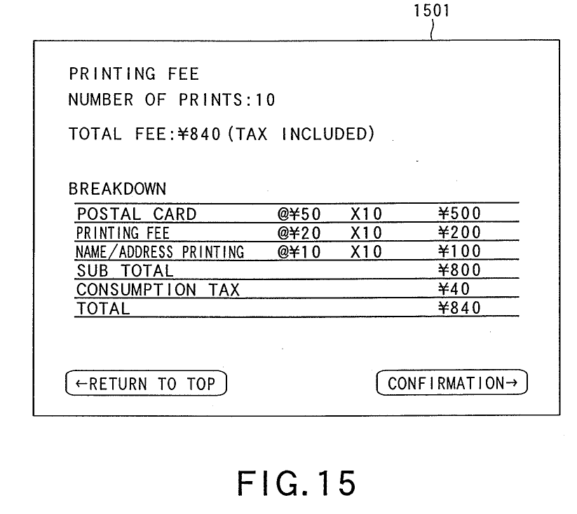

When the user makes various operations through the steps described thus far, the procedures reaches the step S2144, where the in-store automatic printing apparatus 100 displays a screen 1501 shown in FIG. 15 on the display device provided on the vending user interface 101 (S2144).

The contents displayed in the step S2144 includes a breakdown of a service fee charged when the user-specified printing materials are printed. The in-store automatic printing material 100 prompts the user to confirm the displayed contents.

FIG. 15 shows the case where ten pieces of printing material are going to be printed according to the present embodiment. In FIG. 15, a breakdown of the printing fee is shown.

In other words, the screen displays the contents as follows; 500 yen for 10 postal cards, 200 yen for printing images on 10 postal cards, 100 yen for the destination name/address printing service on 10 postal cards, 40 yen as a consumption tax, and total amount of 840 yen.

Two buttons “RETURN TO TOP” and “CONFIRMATION” are provided as the options of the final decision of the user in the step S2144.

When the user selects the button “RETURN TO TOP” through the touch panel as the user interface as described above, the procedure goes to the step S2102 shown in FIG. 21 and returns to the initial operation.

When the user presses the button “CONFIRMATION” in the step S2145, the procedure goes to the step S2146.

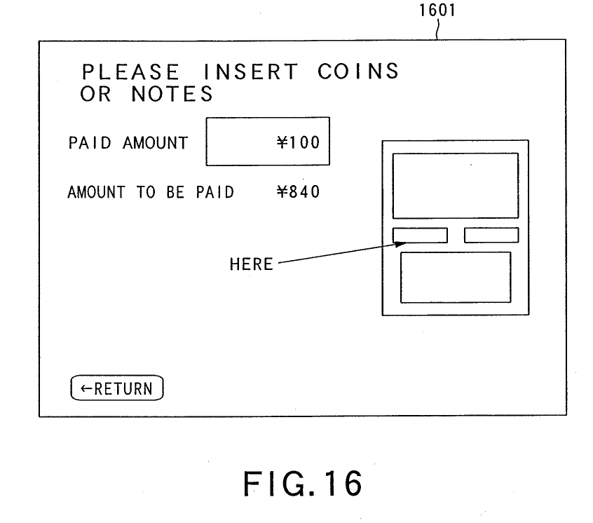

When the user has approved in the step S2145, the in-store automatic printing apparatus 100 displays a screen 1601 shown in FIG. 16 on the display device provided on the vending user interface 101.

The in-store automatic printing apparatus 100 then prompts the user to insert the amount of money through the screen shown in FIG. 16 (S2146).

The user inserts the fee according to the instructions shown in FIG. 16. The in-store automatic printing apparatus 100 determines whether or not the amount of money displayed on the screen 1501 (840 yen in the present embodiment) is inserted (S2147).

When the requested amount of money is inserted, the procedure goes to the step S2148, and if not, the procedure goes back to the step S2146.

Then, the in-store automatic printing apparatus 100 displays the amount of money that the user has already inserted through a screen 1601.

In the screen 1601 according to the present embodiment, a state in which the user inserted 100 yen for the requested amount of money, 840 yen.

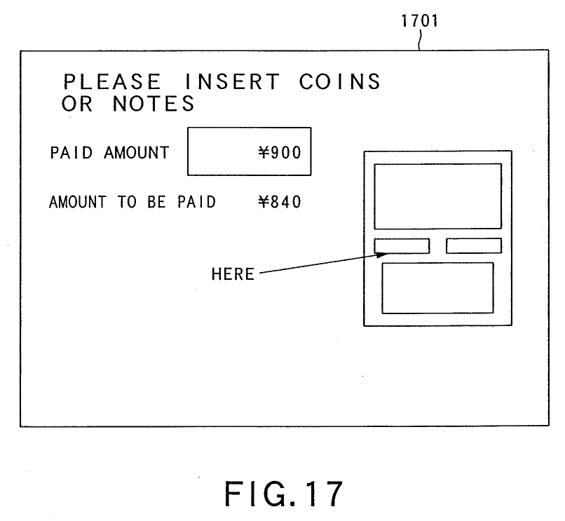

Subsequently, when the user inserted the requested amount of money in the step S2147, the in-store automatic printing apparatus 100 display a screen 1701 shown in FIG. 17 on the display device provided on the vending user interface 101 (S2148).

The screen 1701 in FIG. 17 shows that the user has inserted 900 yen for the requested amount of money, 840 yen.

The in-store automatic printing apparatus 100 determines whether or not the user needs to get change returned (S2149) through the steps described thus far.

If the apparatus have to return the change to the user, the procedure goes to the step S2150, and if not, the procedure goes to the step S2154.

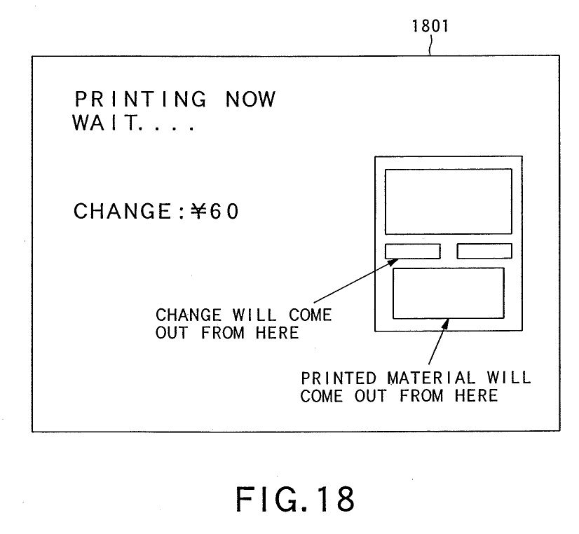

When it is concluded that the apparatus has to return the change in the step S2149, the in-store automatic printing apparatus 100 displays a screen 1801 shown in FIG. 18 on the display device provided on the vending user interface 101 (S2150).

Subsequently, as shown on the screen in FIG. 18, which is displayed in the step S2149, the in-store automatic printing apparatus 100 returns 60 yen as the change for the user using a pay-back means mounted on the apparatus (S2151) in the present embodiment.

This pay-back means is a mechanism for managing insertion of the service fee by the user and payment of change in this step. It is performed by a money I/F 105 shown in FIG. 1.

Such an operation is already implemented in so-called vending machines, and thus will not be described here.

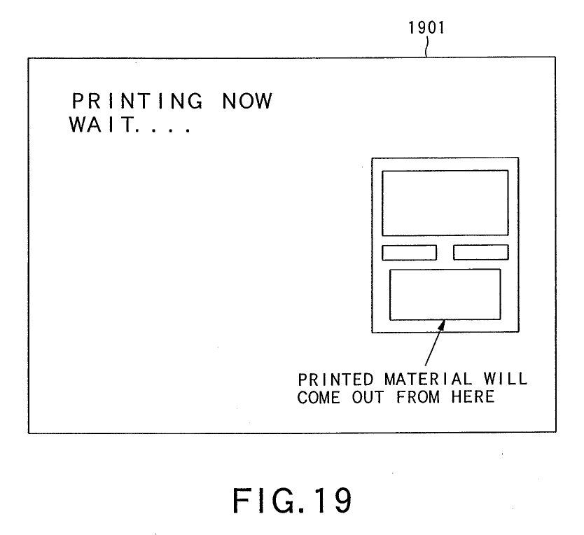

Although the case in which the user has to get change has been described in the present embodiment, when no change is necessary, the in-store automatic printing apparatus 100 displays a screen 1901 shown in FIG. 19 on the display device provided on the vending user interface 101 (S2154).

In the present embodiment, the difference of processing between the case where the user has to get change and the case where no change is necessary is the difference of whether or not the apparatus displays about change on a screen, and hence whether or not the apparatus pays back the change, as a matter of course.

The in-store automatic printing apparatus 100 shown in the present embodiment performs the printing operation specified by the user by using the vending printing device 106 provided in the apparatus (S2155).

Since the details of the printing method are not specifically limited, description will not be made.

For example, in this embodiment, in view of the printing speed, and in view of destination name/address service, a color LBP (Color Laser Beam Printer: publicly known) which is capable of double-face printing is employed.

As in the same case of the printing process system, since the rasterizing process for realizing plot printing in the printing process, for example, the font image (font rasterize) that must be produced for printing the destination names/addresses, which has been described thus far, is not specifically limited, it will not be described here as well.

An example of printing postal cards has been descried in the present embodiment thus far.

In this case, the postal cards are setup in the vending printing apparatus 106 of the present embodiment in advance by the administrator.

After all these processing has completed, the user-desired printing and a series of fee trade are completed.

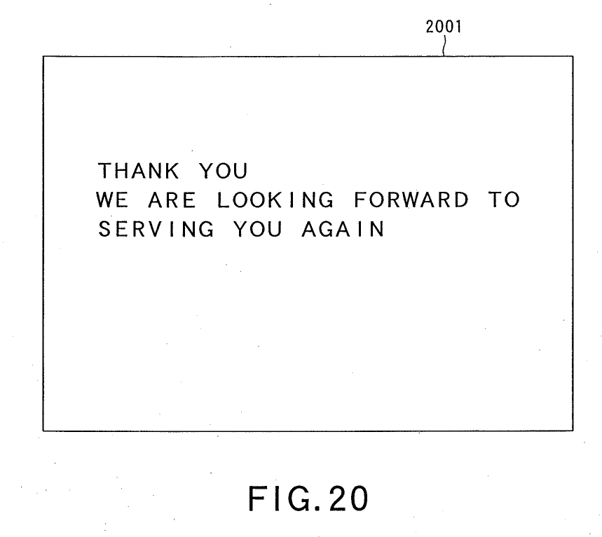

The in-store automatic printing apparatus 100 displays a screen 2001 shown in FIG. 20 on the display device provided on the vending user interface 101 (S2156).

The in-store automatic printing apparatus 100 terminates all the processing after an appropriate timeout processing (that is, after a time period, which is sufficient for the user to recognize a display on the screen 2001 in this step).

Then, the in-store automatic printing apparatus 100 returns the step S2102 shown in FIG. 21 for being ready for the next user.

In the present embodiment, the error handling for the printing job, or processing for error recovery are not described.

However, actually, according to the present embodiment, display for prompting the user to notify occurrence of errors to the staff is necessary.

In this manner, according to the first embodiment of the printing system of the invention, the user can perform printing using data stored in the image data server 107 and data stored in the user data server 108 in the in-store automatic printing apparatus 100, and thus an on-demand printing system is provided with a high flexibility, whereby the supplier can broaden the business opportunities.

### Second Embodiment of the Printing System

Subsequently, a second embodiment of the printing system according to the invention will be described. Since the construction of the second embodiment is the same as the first embodiment of the printing system according to the invention, the same construction and operation will not be described in detail.

In the aforementioned embodiment, the user accesses the home server through the network or uses the user's own memory card when using the destination name/address service.

However, the invention is not limited thereto, and the user may use the data by accessing to the address book installed in a handy phone, which is in widespread use recently, through the IRDA (publicly known) and a wireless network, or using a telephone function.

Therefore, in the present embodiment, the same effects as in the first embodiment of the printing system according to the present invention, and the flexible service may be provided.

The destination name/address database format or the data format may be any type as long as it can communicate and exchange information with the in-store automatic printing apparatus.

In the embodiments described above, an example in which the final destination of processing is determined corresponding to the selection of the screen by the user during the processing has been described.

However, the destination of processing itself is not specifically limited as long as the user can operate generally smoothly as the user interface.

The contents displayed on the display device provided on the vending user interface 101 are not specifically limited.

In the embodiments described above, the contents to be printed are not specifically limited.

For example, as the method used for retrieving the destination printing option in the database, the printing image contents may be obtained from the home server or the user's own storage medium for printing.

In the embodiments described above, the service fee is to be paid on the spot.

However, payment of the fee is not limited to cash in the invention and, for example, various modes including payment by a prepaid card or a cash card, or later payment with billing address confirmed when accessing the home server through the network may also be applicable.

In the embodiments described above, postcards, which are generally used for Summer greetings or New Year's greetings, are taken as an example of the printing material.

However, the printing material is not limited thereto.

For example, even when other printing materials which match to the needs, such as name cards or envelopes, to be printed are selected for eliminating troublesome handwriting work or for obtaining high-quality output, the same effects can be achieved through the similar measure, although it is necessary to change the user interface so as to match the service.

As described above, according to the embodiment of the present invention, the in-store automatic printing apparatus 100 as a printing apparatus is connected to the image data server 107 through the network 109, and obtains image information specified by the user from the image data server 107.

In the embodiment of the invention, information entered by the user through the user data server 108 connected to the network 110, the storage medium, and the user interface is used as user-specific information.

Furthermore, according to the embodiment of the invention, the in-store automatic printing apparatus 100 as a printing apparatus generates printing images based on image information and user-specific information.

As is described thus far, according to the embodiments of the invention, since images required for printing can easily be generated, a printing job which matches the user's needs may be performed.

1.-28. (canceled)

29. A printing apparatus connected to an image data server storing image information by network comprising:
an image selection unit which has a user select a printing image;
a specification unit which has the user specify whether or not to print a destination;
a destination input selection unit which has the user select an input source of a destination information from a home server or a storage medium held by the user, in the case that the user specifies to print the destination by the specification unit;
a destination information acquisition unit which obtains the destination information from the home server in the case that the user selects the home server by the destination input selection unit, and which obtains the destination information from the storage medium in the case that the user selects the storage medium by the destination input selection unit;
a print number specification unit which has the user specify a print number; and
a printing unit which has the user specify the print number by the print number specification unit and prints copies of the printing image as many as the specified print number in the case that the user specifies not to print the destination, and which obtains the destination information by the destination information acquisition unit and prints the obtained destination information and the printing image in the case that the user specifies to print the destination.

30. A printing apparatus according to claim 29, wherein the destination information acquisition unit has the user specify a URL of a home server storing the destination information in the case of obtaining the destination information from the home server, and obtains the destination information from the specified home server.

31. A printing apparatus according to claim 29, further comprising a text entry unit which has the user enter a text, wherein the printing unit prints the entered text together with the printing image.

32. A printing apparatus according to claim 29, wherein the storage medium held by the user is a storage medium in a mobile terminal held by the user, and the destination information acquisition unit performs wireless communication with the mobile terminal to obtain the destination information stored in the storage medium in the mobile terminal.

33. A printing method executed by a printing apparatus connected to an image data server storing image information by network, the printing method comprising the steps of:
having a user select a printing image;
having the user specify whether or not to print a destination;
in the case that the user specifies not to print the destination, having the user specify a print number and printing copies of the printing image as many as the specified print number; and
in the case that the user specifies to print the destination, having the user select an input source of a destination information from a home server or a storage medium held by the user, obtaining the destination information from the home server in the case that the home server is selected or from the storage medium in the case that the storage medium is selected, and printing the obtained destination information and the printing image.

34. A printing method according to claim 33, wherein the step of obtaining the destination information from the home server includes the steps of:
having the user specify a URL of a home server storing the destination information; and
obtaining the destination information from the specified home server.

35. A printing method according to claim 33, further comprising the steps of:
having the user enter a text; and
printing the entered text together with the printing image.

36. A printing method according to claim 33, wherein the storage medium held by the user is a storage medium in a mobile terminal held by the user, and wherein the step of obtaining the destination information from the storage medium includes a step of performing wireless communication with the mobile terminal to obtain the destination information stored in the storage medium in the mobile terminal.

37. A program executed by a printing apparatus connected to an image data server storing image information by network, the program comprising:
code for having a user select a printing image;
code for having the user specify whether or not to print a destination;
code, in the case that the user specifies not to print the destination, for having the user specify a print number and for printing copies of the printing image as many as the specified print number; and
code, in the case that the user specifies to print the destination, for having the user select an input source of a destination information from a home server or a storage medium held by the user, for obtaining the destination information from the home server in the case that the home server is selected or from the storage medium in the case that the storage medium is selected, and for printing the obtained destination information and the printing image.

38. A program according to claim 37, wherein the code for obtaining the destination information from the home server includes code for having the user specify a URL of a home server storing the destination information and code for obtaining the destination information from the specified home server.

39. A program according to claim 37, further comprising code for having the user enter a text and code for printing the entered text together with the printing image.

40. A printing system comprising:
an image data server storing image information;
a home server storing destination information; and
a printing apparatus, wherein the printing apparatus comprises:
an image selection unit which has a user select a printing image from images stored in the image data server;
a specification unit which has the user specify whether or not to print a destination;
a destination input selection unit which has the user select an input source of a destination information from the home server or a storage medium held by the user, in the case that the user specifies to print the destination by the specification unit;
a destination information acquisition unit which has the user specify a URL of the home server and obtains the destination information from the home server in the case that the user selects the home server by the destination input selection unit, and which obtains the destination information from the storage medium in the case that the user selects the storage medium by the destination input selection unit;
a print number specification unit which has the user specify a print number; and
a printing unit which has the user specify the print number by the print number specification unit and prints copies of the printing image as many as the specified print number in the case that the user specifies not to print the destination, and which obtains the destination information by the destination information acquisition unit and prints the obtained destination information and the printing image in the case that the user specifies to print the destination.

41. A printing system according to claim 40, wherein the printing apparatus further comprises a text entry unit which has the user enter a text, and wherein the printing unit prints the entered text together with the printing image.

42. A printing system according to claim 40, wherein the storage medium held by the user is a storage medium in a mobile terminal held by the user, and the destination information acquisition unit performs wireless communication with the mobile terminal to obtain the destination information stored in the storage medium in the mobile terminal.
